(19) United States
(12) Patent Application Publication
(10) Pub. No.: US 2024/0100839 A1
(43) Pub. Date: Mar. 28, 2024

(54) IMAGE FORMING APPARATUS THAT PERFORMS CORRECTION PROCESSING BASED ON TARGET NOZZLE

(71) Applicant: KYOCERA Document Solutions Inc., Osaka (JP)

(72) Inventors: Masato USUI, Osaka (JP); Hiroomi NAKATSUJI, Osaka (JP); Naoko KAWASHIMA, Osaka (JP); Jun NAKANO, Osaka (JP)

(73) Assignee: KYOCERA Document Solutions Inc., Osaka (JP)

(21) Appl. No.: 18/367,097

(22) Filed: Sep. 12, 2023

(30) Foreign Application Priority Data
Sep. 22, 2022 (JP) 2022-151918

(51) Int. Cl. B41J 2/165; B41J 2/155

(52) U.S. Cl. CPC B41J 2/16579; B41J 2/155; B41J 2/2142

(57) ABSTRACT

An image forming apparatus includes a recording head, a controller, and a correction processor. The controller determines a nozzle corresponding to an image to be printed, and causes the recording head to eject ink from the nozzle. The correction processor detects an abnormally ejecting nozzle out of the nozzles in the recording head, and designates the abnormally ejecting nozzle as a target nozzle, and performs correction processing based on a status of the target nozzle, to the image. The correction processor also adds the detected abnormally ejecting nozzle to history data, each time a detecting operation is performed, and selects a nozzle included in the history data as an additional target nozzle, out of the nozzles that have not been detected as the abnormally ejecting nozzle, through the current detecting operation, and adds the selected nozzle to the target nozzle.

### INCORPORATION BY REFERENCE

This application claims priority to Japanese Patent Application No. 2022-151918 filed on Sep. 22, 2022, the entire contents of which are incorporated by reference herein.

### BACKGROUND

The present disclosure relates to an image forming apparatus that performs a correction processing based on a target nozzle.

Some of existing ink jet image forming apparatuses are configured to print a test pattern with a recording head, to detect an abnormally ejecting nozzle in the recording head, on the basis of the read image of the test pattern, and to restrict the abnormally ejecting nozzle from ejecting the ink, and increase the ejection amount of the corresponding adjacent dot.

Some other ink jet image forming apparatuses are configured to presume a nozzle from which the ink has not been ejected for a predetermined consecutive period of time, out of the nozzles of the recording head, to be the abnormally ejecting nozzle, and to restrict the presumed abnormally ejecting nozzle from ejecting the ink, and adjust the ejection amount of the corresponding adjacent dot.

### SUMMARY

The disclosure proposes further improvement of the foregoing techniques.

In an aspect, the disclosure provides an image forming apparatus including a recording head and a control device. The recording head includes a nozzle array that ejects an ink corresponding to an image to be printed. The control device includes a CPU, and acts as a controller and a correction processor, when the CPU executes a control program. The controller determines the nozzle corresponding to the image to be printed, and causes the recording head to eject the ink from the nozzle. The correction processor (a) detects an abnormally ejecting nozzle out of the nozzles in the recording head, and designates the abnormally ejecting nozzle as a target nozzle, and (b) performs correction processing based on a status of the target nozzle, to the image. The correction processor also (a) adds the detected abnormally ejecting nozzle to history data, each time a detecting operation is performed, and (b) selects a nozzle included in the history data as an additional target nozzle, out of the nozzles that have not been detected as the abnormally ejecting nozzle, through a current detecting operation, and adds the selected nozzle to the target nozzle.

### BRIEF DESCRIPTION OF THE DRAWINGS

FIG. 1 is a schematic side view showing a mechanical internal configuration of an image forming apparatus according to an embodiment of the disclosure;

FIG. 2 is a plan view showing an example of recording heads 1a, 1b, 1c, and 1d, provided in the image forming apparatus shown in FIG. 1;

FIG. 3 is a block diagram showing an electrical configuration of the image forming apparatus according to the embodiment of the disclosure;

FIG. 4 is a flowchart for explaining an operation performed by the image forming apparatus shown in FIG. 1 to FIG. 3, to designate a target nozzle; and

FIG. 5 is a table for explaining the number of appearances of abnormally ejecting nozzles, during a successive printing operation of 20,000 pages, with the image forming apparatus 10 according to the embodiment of the disclosure.

### DETAILED DESCRIPTION

Hereafter, an image forming apparatus 10 according to an embodiment of the disclosure will be described, with reference to the drawings. The object, feature, and advantages of the disclosure will become more apparent, through detailed description given hereunder with reference to the accompanying drawings.

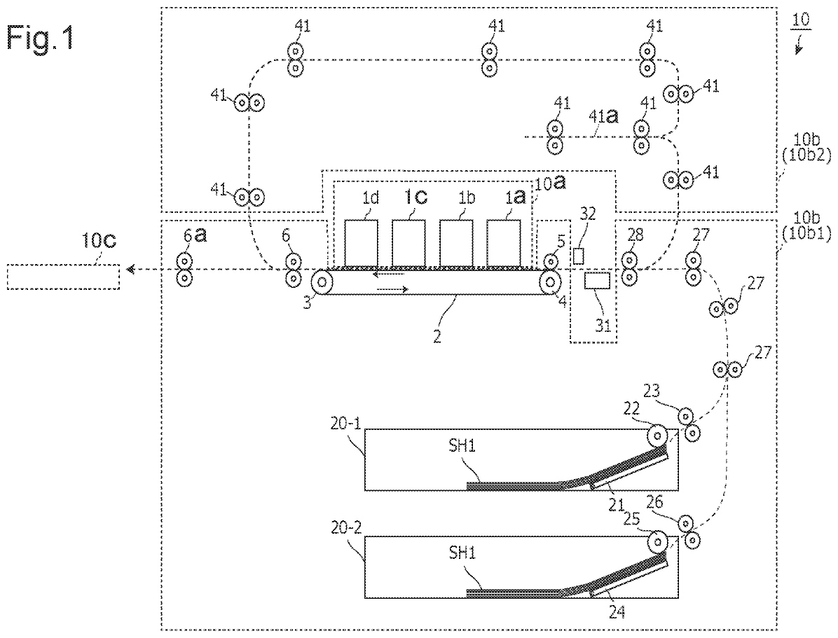

FIG. 1 is a schematic side view showing a mechanical internal configuration of the image forming apparatus according to the embodiment of the disclosure. The image forming apparatus 10 according to this embodiment is configured, for example, as a printer, a copier, a facsimile machine, or a multifunction peripheral.

The image forming apparatus 10 shown in FIG. 1 includes a print engine 10a and a sheet transport device 10b. The print engine 10a physically forms a page image to be printed, on a printing sheet SH1. In this embodiment, the print engine 10a line-head type ink jet printing device.

In this embodiment, the print engine 10a includes recording heads 1a to 1d, each configured as a line type, and respectively corresponding to four ink colors, namely cyan, magenta, yellow, and black.

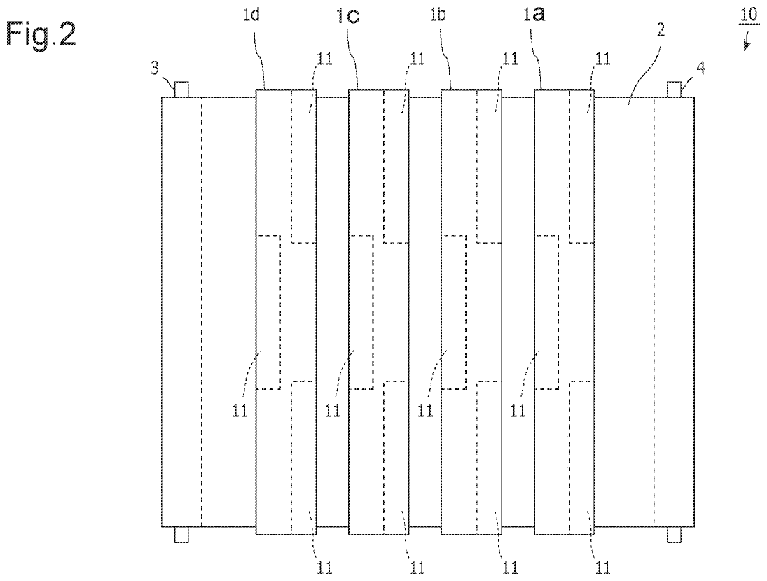

FIG. 2 is a plan view showing an example of the recording heads 1a, 1b, 1c, and 1d, in the image forming apparatus 10 shown in FIG. 1. In this embodiment, for example as shown in FIG. 2, the recording heads 1a, 1b, 1c, and 1d each include a plurality of (in this embodiment, four) head units 11. These head units 11 extend in the main scanning direction, and removably mounted on the apparatus main body. Here, the recording heads 1a, 1b, 1c, and 1d may each include only one head unit 11. Each of the head units 11 of the recording heads 1a, 1b, 1c, and 1d includes nozzles arranged in a two-dimensional pattern so as to correspond to ejecting positions aligned in the main scanning direction, so that the ink corresponding to the image to be printed is ejected from those nozzles.

The sheet transport device 10b transports the printing sheet SH1, unprinted yet, to the print engine 10a along a predetermined transport route, and transports the printing sheet SH1 that has undergone the printing operation, from the print engine 10a to a predetermined destination (e.g., output tray 10c).

The sheet transport device 10b includes a main sheet transport device 10b1 and a circulating sheet transport device 10b2. In the case of duplex printing, the main sheet transport device 10b1 transports the printing sheet SH1 to be used for printing of a page image for a first face to the print engine 10a, and the circulating sheet transport device 10b2 transports the printing sheet SH1 from the rear end of the print engine 10a to the front end thereof, while detaining a predetermined number of printing sheets SH1.

In this embodiment, the main sheet transport device 10b1 includes an annular transport belt 2 opposed to the print engine 10a, and configured to transport the printing sheet SH1, a drive roller 3 and a follower roller 4 around which the transport belt 2 is stretched, an adsorption roller 5 for nipping the printing sheet SH1 in collaboration with the transport belt 2, and delivery roller pairs 6 and 6a.

The drive roller 3 and the follower roller 4 serve to circulate the transport belt 2. The adsorption roller 5 nips the printing sheet SH1 transported from a sheet cassette 20-1 or 20-2, to be subsequently described, and the nipped printing sheet SH1 is transported by the transport belt 2 to the respective printing positions of the recording heads 1a to 1d sequentially, so that the images of the respective colors are printed by the recording heads 1a to 1d. Then the printing sheet SH1, on which the color printing has been executed, is delivered to the output tray 10c, by the delivery roller pairs 6 and 6a.

The main sheet transport device 10b1 also includes the plurality of sheet cassettes 20-1 and 20-2. The sheet cassettes 20-1 and 20-2 are for storing the printing sheets SH1, and include a lifting plate 21, 24 for lifting up the printing sheet SH1 to bring the printing sheet SH1 into contact with a pickup roller 22, 25. The printing sheets SH1 placed in the sheet cassette 20-1 or 20-2 are picked up by the pickup roller 22 or 25 one by one from the uppermost one, and delivered to a feeding roller 23 or 26. The feeding rollers 23 and 26 each serve to feed the printing sheet SH1, delivered by the pickup roller 22 or 25 from the sheet cassette 20-1 or 20-2, one by one to the transport route. The transport rollers 27 are provided on the transport route commonly utilized by the printing sheets SH1 delivered from both of the sheet cassettes 20-1 and 20-2.

The circulating sheet transport device 10b2 serves to return, when the duplex printing is executed, the printing sheet SH1 from a predetermined position downstream of the print engine 10a, to another predetermined position on the upstream side (in this embodiment, predetermined position upstream of a line sensor 31 to be subsequently described). The circulating sheet transport device 10b2 includes transport rollers 41, and a switchback transport route 41a that reverses the moving direction of the printing sheet SH1, to switch the face of the printing sheet SH1 to be opposed to the print engine 10a from the first face to a second face.

Further, the image forming apparatus 10 includes the line sensor 31 and a sheet sensor 32.

The line sensor 31 is an optical sensor located along a direction orthogonal to the transport direction of the printing sheet SH1, to detect the positions of the respective edges (side edges) of the printing sheet SH1. The line sensor 31 is, for example, a contact image sensor (CIS). In this embodiment, the line sensor 31 is located between a resist roller 28 and the print engine 10a.

The sheet sensor 32 is an optical sensor for detecting that the leading edge of the printing sheet SH1 has passed a predetermined position on the transport route. The line sensor 31 detects the positions of the respective edges of the printing sheet SH1, at the time that the sheet sensor 32 has detected the leading edge of the printing sheet SH1.

For example as shown in FIG. 1, the print engine 10a is provided on one of the upper side and the lower side (in this embodiment, the upper side) of the transport route of the printing sheet SH1, the line sensor 31 is located on the other of the upper side and the lower side (in this embodiment, the lower side) of the transport route of the printing sheet SH1, and the circulating sheet transport device 10b2 transports the printing sheet SH1 by switching back from the downstream side of the print engine 10a to the upstream side of the line sensor 31.

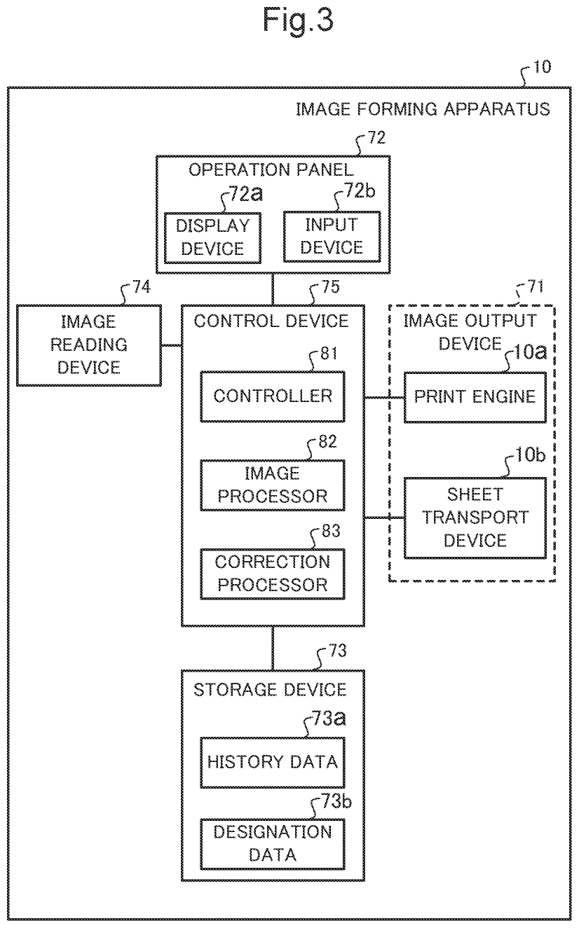

FIG. 3 is a block diagram showing an electrical configuration of the image forming apparatus 10 according to the embodiment of the disclosure. As shown in FIG. 3, the image forming apparatus 10 further includes, in addition to the image output device 71 having the mechanical configuration shown in FIG. 1 and FIG. 2, an operation panel 72, a storage device 73, an image reading device 74, and a control device 75.

The operation panel 72 is provided on the front face of the casing of the image forming apparatus 10, and includes a display device 72a, for example constituted of an LCD, and an input device 72b having hard keys and a touch panel, to display messages to the user on the display device 72a, and receives operations of the user through the input device 72b.

The storage device 73 is a non-volatile memory unit (e.g., flash memory or had disk drive), for storing data and programs necessary for controlling the image forming apparatus 10.

The image reading device 74 includes a scanner, a platen glass, and an automatic document feeder, and optically reads the image of a document placed on the platen glass, or a document delivered from the automatic document feeder, to thereby generate image data of the read image.

The control device 75 includes a computer that executes software processes according to a program, predetermined hardware processing, and an application specific integrated circuit (ASIC), to act as various types of processors. The computer includes a central processing unit (CPU), a read-only memory (ROM), and a random-access memory (RAM), and acts as various types of processors (in collaboration with the ASIC as necessary), by loading a control program stored in the ROM or storage device 73 on the RAM, and executing the control program with the CPU. In this embodiment, the control device 75 acts as a controller 81, an image processor 82, and a correction processor 83.

The controller 81 controls the image output device 71 (specifically, print engine 10a and sheet transport device 10b), to thereby executes a print job requested by the user. In this embodiment, the controller 81 causes the image processor 82 to perform predetermined image processing, and controls the print engine 10a (head units 11) so as to eject the ink, thereby forming a printed image on the printing sheet SH1. The image processor 82 performs the predetermined image processing, such as raster image processing (RIP), color conversion, or half toning, with respect to the image data representing the image to be printed on the printing sheet SH1.

In other words, the controller 81 causes the print engine 10a to print an image requested by the user, on the basis of the image data representing the image to be printed designated by the user.

In this embodiment, further, the controller 81 has an automatic centering function, including (a) identifying the center position of the printing sheet SH1 as an actual sheet center position, on the basis of the positions of the respective edges of the printing sheet SH1 detected by the line sensor 31, and (b) adjusting the center position of the image to be printed, according to the actual sheet center position, and executes the automatic centering function in the form of hardware processing. To be more specific, in the automatic centering function, the controller 81 shifts the drawing position of the image to be printed, along the main scanning direction, by an amount corresponding to the difference between the reference center position of the print engine 10a and the actual sheet center position. In this embodiment, since the nozzles of the recording heads 1a to 1d are not configured to move, the nozzles corresponding to the respective pixels in the image to be printed are changed, according to the drawing position of the image to be printed.

Thus, the controller 81 determines the nozzles corresponding to the image to be printed (nozzles corresponding to the respective pixels of the image) (in this embodiment, according to the position of the printing sheet SH1), and causes the recording head 1a to 1d to eject the ink from the nozzles.

The correction processor 83 detects an abnormally ejecting nozzle out of the nozzles of the recording heads 1a to 1d, and designates the detected abnormally ejecting nozzle as a target nozzle. The correction processor 83 then performs a correction processing (in this embodiment, hardware processing) based on the status of the target nozzle, to the image to be printed. In this correction processing, for example, the image data of the pixel corresponding to the abnormally ejecting nozzle is corrected to a pixel value indicating non-ejection, and the image data of a pixel, adjacent to the pixel corresponding to the abnormally ejecting nozzle, is corrected to a predetermined higher density value.

In the mentioned detection, to be more detailed, the correction processor 83 (a) causes the controller 81 to print a test pattern with the recording heads 1a to 1 d, and (b) identifies the abnormally ejecting nozzle (e.g., nozzle causing deviated ejection or non-ejection), on the basis of the image of the test pattern that has been read. More specifically, an abnormal ejection position is identified in the read image, and the nozzle corresponding to the abnormal ejection position (i.e., nozzle supposed to eject the ink to the abnormal ejection position) is identified as the abnormally ejecting nozzle. Here, the term “deviated ejection” refers to a state where the landing position of the ink droplet ejected from the nozzle is deviated in the main scanning direction. In addition, the read image of the test pattern is acquired through the line sensor 31 or the image reading device 74. When the line sensor 31 is used to read the test pattern, the printing sheet SH1 on which the test pattern has been printed by the print engine 10a is transported to the position of the line sensor 31, along the circulating sheet transport device 10b2. The test pattern includes, for example, one-dot fine lines in the sub scanning direction, corresponding to the respective nozzles, and bands in the main scanning direction.

Further, the correction processor 83 (a) adds the detected abnormally ejecting nozzle to history data 73a, each time the detecting operation is performed, and (b) selects a nozzle included in the history data 73a as an additional target nozzle, out of the nozzles that have not been detected as the abnormally ejecting nozzle, through the current detecting operation, and adds the selected nozzle to the target nozzle.

The history data 73a is stored in the storage device 73, and updated by adding the detected abnormally ejecting nozzle, each time the correction processor 83 performs the detecting operation. In addition, the history data 73a contains the abnormally ejecting nozzles detected through a predetermined number of times of detecting operations, and the abnormally ejecting nozzle detected earlier is deleted from the history data 73a. Further, the designation of the target nozzle (abnormally ejecting nozzle and additional target nozzle) is stored by the correction processor 83 in the storage device 73, as designation data 73b.

In this embodiment, the correction processor 83 selects, out of the nozzles contained in the history data 73a, the nozzles detected as the abnormally ejecting nozzle, detected through a predetermined number times of latest detecting operations (e.g., three times), other than the current detection, as the additional target nozzle.

In this embodiment, further, when the number of abnormally ejecting nozzles identified through the current detecting operation is equal to or larger than a predetermined upper limit (upper limit of the number of abnormal ejection positions to which the correction processing is to be executed), the correction processor 83 does not add the additional target nozzle to the target nozzles. When the number of abnormally ejecting nozzles identified through the current detecting operation is fewer than the predetermined upper limit, the correction processor 83 adds the additional target nozzle to the target nozzles, such that the number of target nozzles does not exceed the predetermined upper limit.

In other words, in the case of adding the target nozzle, when the number of additional target nozzles is equal to or fewer than a difference between the number of abnormally ejecting nozzles identified through the current detecting operation and the predetermined upper limit, all of the additional target nozzles are added to the target nozzles. On the other hand, in the case of adding the target nozzle, when the number of the additional target nozzles is larger than the difference between the number of abnormally ejecting nozzles identified through the current detecting operation and the predetermined upper limit, a part of the additional target nozzles are added to the target nozzles, but the remaining ones of the additional target nozzles are not added to the target nozzles. In this case, the part of the additional target nozzles, to be added to the target nozzles, is selected according to a predetermined condition (e.g., frequently appearing in the history data 73a, or being detected through a later detecting operation).

In this embodiment, further, the correction processor 83 (a) detects the abnormally ejecting nozzle and selects the additional target nozzle, before a successive printing operation of a predetermined number of pages (e.g., 20,000 pages) is performed, and (b) keeps from performing the detecting operation, during the successive printing operation. In addition, the controller 81 inhibits the cleaning operation of the recording heads 1a to 1d, during the successive printing operation.

Hereunder, an operation of the image forming apparatus 10 will be described.

### (a) Designation of Target Nozzle for Correction Processing

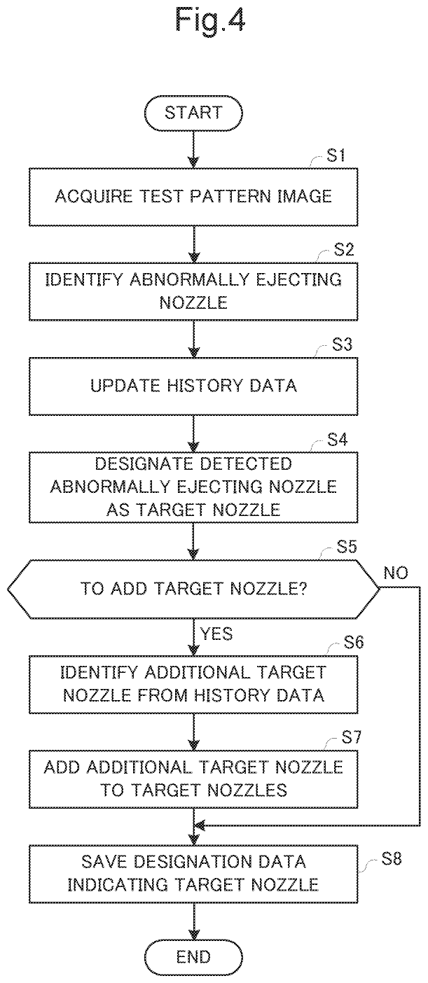

FIG. 4 is a flowchart for explaining an operation performed by the image forming apparatus shown in FIG. 1 to FIG. 3, to designate the target nozzle for the correction processing.

The correction processor 83 repeats the detecting operation of the abnormally ejecting nozzle, at predetermined intervals. In the detection of the abnormally ejecting nozzle, the controller 81 causes the image output device 71 to print the test pattern for identifying the abnormally ejecting nozzle, on the printing sheet SH1, and acquires the read image of the test pattern (image data of each ink color) printed on the printing sheet SH1, through the line sensor 31 or image reading device 74 (step S1). The correction processor 83 then identifies the abnormally ejecting nozzle, on the basis of density distribution in the main scanning direction, in the read image of the test pattern, for example from an abnormal ejection position in the density distribution (e.g., where lack of density is observed) (step S2).

The correction processor 83 adds the abnormally ejecting nozzle identified through the current detecting operation (specifically, identification information such as the nozzle number of the abnormally ejecting nozzle), to the history data 73a (step S3). The correction processor 83 also designates the abnormally ejecting nozzle detected through the current detecting operation, as the target nozzle (step S4).

Further, the correction processor 83 decides whether the target nozzle should be added, on the basis of the history data 73a (step S5).

Here, when the number of abnormally ejecting nozzles detected through the current detecting operation is equal to or larger than the predetermined upper limit, the correction processor 83 does not add the target nozzle. On the other hand, when the number of abnormally ejecting nozzles detected through the current detecting operation is fewer than the predetermined upper limit, the correction processor 83 adds the target nozzle.

When the number of abnormally ejecting nozzles detected through the current detecting operation is larger than the predetermined upper limit, the correction processor 83 reduces the number of target nozzles, so as to make the number of target nozzles the same as the predetermined upper limit. Further, when adding the target nozzle, the correction processor 83 adds the target nozzles, such that the number of target nozzles after the addition does not exceed the predetermined upper limit.

Upon deciding that the target nozzle should be added, the correction processor 83 identifies the nozzle to be added as above, on the basis of the history data 73a (step S6), and adds the identified nozzle to the target nozzles (step S7). In contrast, upon deciding that the target nozzle should not be added, the correction processor 83 keeps from adding the target nozzle on the basis of the history data 73a.

Then the correction processor 83 stores the designation data 73b indicating the target nozzle designated as above, in the storage device 73 (step S8). That is how the target nozzle is designated.

### (b) Printing Operation

Upon receipt of a print request, the controller 81 causes the image processor 82 to perform image processing with respect to the image designated by the print request, to thereby obtain the image data representing the image to be printed, causes the image output device 71 to transport the printing sheet SH1 and print the image to be printed on the printing sheet SH1, according to the image data.

In this process, the correction processor 83 retrieves the designation data 73b from the storage device 73, before the printing operation is started, and identifies the target nozzle. When the position of the printing sheet SH1 is detected by the line sensor 31, the correction processor 83 (a) identifies the nozzles corresponding to the respective pixels in the image, (b) identifies the target nozzle supposed to be used for the image, and (c) performs the correction processing based on the status of the target nozzle. Accordingly, the correction processing is performed on the position corresponding to the target nozzle (and a nozzle adjacent to the abnormally ejecting nozzle in the main scanning direction). Then the controller 81 executes the printing operation, on the basis of the image data that has been subjected to the correction processing.

According to this embodiment, as described above, the recording heads 1a to 1d each eject the ink corresponding to the image to be printed, from the nozzle array. The controller 81 determines the nozzle corresponding to the image to be printed, and causes the recording heads 1a to 1d to eject the ink from the nozzle. The correction processor 83 (a) detects the abnormally ejecting nozzle out of the nozzles in the recording heads 1a to 1d, and designates the detected abnormally ejecting nozzle as the target nozzle, and (b) performs the correction processing based on the status of the target nozzle, to the image to be printed. The correction processor 83 also (a) adds the detected abnormally ejecting nozzle to the history data 73a, each time the detecting operation is performed, and (b) selects the nozzle included in the history data 73a as the additional target nozzles, out of the nozzles that have not been detected as the abnormally ejecting nozzle, through the current detecting operation, and adds the selected nozzle to the target nozzles.

Accordingly, the nozzle that is likely to repeat the abnormal ejection is added to the target nozzles, on the basis of the history data 73a, and therefore the degradation of the picture quality can be prevented, without compromising the productivity in the successive printing operation.

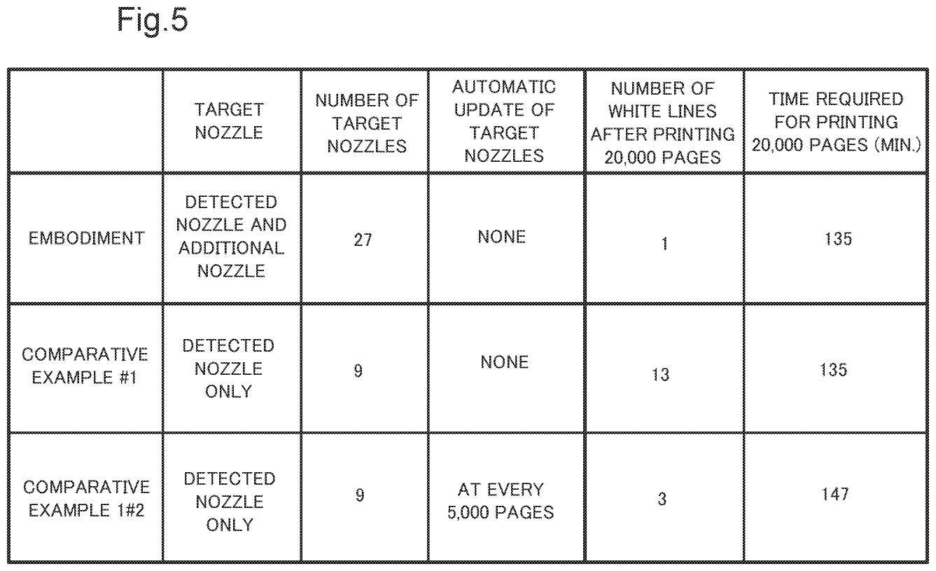

FIG. 5 is a table for explaining the number of appearances of the abnormally ejecting nozzles, during the successive printing operation of 20,000 pages, with the image forming apparatus 10 according to the embodiment of the disclosure.

In the example shown in FIG. 5, the number of appearances of the abnormally ejecting nozzle, after the successive printing operation of 20,000 pages with the image forming apparatus 10 according to this embodiment, is 1 (one white line in the test pattern image, which is a band image). In this table, the nozzle detected at least once, in the three latest detecting operations, other than the current detecting operation, is selected as the additional target nozzle.

On the other hand, a comparative example #1 represents the case where the additional target nozzle is not added, and an automatic update of the target nozzle (update of the designation data 73b by the cleaning operation and the detecting operation) is not performed, halfway of the successive printing operation. In the case of the comparative example #1, the number of appearances of the abnormally ejecting nozzle, after the successive printing operation of 20,000 pages is 13 (i.e., 13 white lines in the test pattern image). A comparative example #2 represents the case where the additional target nozzle is not added, and the automatic update of the target nozzle is performed at every 5,000 pages, halfway of the successive printing operation. In the case of the comparative example #2, the number of appearances of the abnormally ejecting nozzle, after the successive printing operation of 20,000 pages is 3 (i.e., three white lines in the test pattern image). In the case of the comparative example #2, however, the time required for the successive printing operation is increased, because of the automatic update of the target nozzle performed halfway of the successive printing operation.

As described above, with the image forming apparatus according to this embodiment, the correction processing is performed also with respect to the nozzle that is relatively likely to cause the abnormal ejection during the successive printing operation, because of the addition of the additional target nozzle to the target nozzles. Therefore, the degradation of the picture quality can be prevented, without compromising the productivity.

Now, performing the cleaning operation of the recording head (nozzles) can temporarily solve the problem of abnormal ejection of the nozzle. However, in the case of the successive printing operation of many pages, water repellency of the opening of the nozzle may be degraded, which may provoke abnormal ejection, resulting in degradation in picture quality. In other words, the abnormal ejection may occur during the printing operation, even in the nozzles that are ejecting the ink, and it is difficult for the aforementioned existing image forming apparatuses to recognize such abnormal ejection of the nozzles. Further, although it is possible to suppress the abnormal ejection, by performing the cleaning operation halfway of the successive printing operation, in this case the time required for the successive printing operation is prolonged.

With the arrangement according to the foregoing embodiment, in contrast, the degradation of the picture quality can be prevented, without compromising the productivity of the successive printing operation.

Various changes and modifications to the foregoing embodiment are obvious to those skilled in the art. Such changes and modifications may be made without departing from the scope and spirit of the subject, and without impairing the intended advantages. Accordingly, such changes and modifications should be construed to be included in the scope of the disclosure.

In the foregoing embodiment, for example, whether the additional target nozzle may be added to the target nozzle may be determined according to a user setting or a user operation.

The disclosure is applicable, for example, to the field of ink jet image forming apparatuses.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
a recording head including a nozzle array that ejects an ink corresponding to an image to be printed;
a control device including a CPU, and configured to act, when the CPU executes a control program, as a controller that determines the nozzle corresponding to the image to be printed, and cause the recording head to eject the ink from the nozzle, and a correction processor that acts as a correction processor that (a) detects an abnormally ejecting nozzle out of the nozzles in the recording head, and designates the abnormally ejecting nozzle as a target nozzle, and (b) performs correction processing based on a status of the target nozzle, to the image,
wherein the correction processor also (a) adds an information indicating the detected abnormally ejecting nozzle to history data, each time a detecting operation is performed, and (b) selects a nozzle included in the history data as an additional target nozzle, out of the nozzles that have not been detected as the abnormally ejecting nozzle, through a current detecting operation, and adds the selected nozzle to the target nozzle.

2. The image forming apparatus according to claim 1,
wherein the correction processor (a) performs the detecting operation of the abnormally ejecting nozzle before a successive printing operation of a predetermined number of pages, and adds the additional target nozzle to the target nozzle, and (b) keeps from performing the detecting operation, during the successive printing operation.

3. The image forming apparatus according to claim 2, wherein the controller controls operation of the image forming apparatus, and inhibits a cleaning operation of the recording head, during the successive printing operation.

4. The image forming apparatus according to claim 1,
wherein the correction processor selects, out of the nozzles contained in the history data, a nozzle detected as the abnormally ejecting nozzle, in a predetermined number of times of latest detecting operations, other than a current detecting operation, as the additional target nozzle.

5. The image forming apparatus according to claim 1,
wherein, when a number of the abnormally ejecting nozzles identified through the current detecting operation is equal to or larger than a predetermined upper limit, the correction processor keeps from adding the additional target nozzle to the target nozzle, and when the number of the abnormally ejecting nozzles identified through the current detecting operation is fewer than the predetermined upper limit, the correction processor adds the additional target nozzle to the target nozzle, such that a number of the target nozzles does not exceed the predetermined upper limit.

6. The image forming apparatus according to claim 1,
wherein the correction processor performs the detecting operation of the abnormally ejecting nozzle, out of the nozzles of the recording head, designates the detected abnormally ejecting nozzle as the target nozzle, and performs the correction processing based on the target nozzle, and
in the correction processing, image data of a pixel corresponding to the abnormally ejecting nozzle is corrected to a pixel value indicating non-ejection, and image data of a pixel, adjacent to the pixel corresponding to the abnormally ejecting nozzle, is corrected to a predetermined higher density value.
